(19) United States
(12) Patent Application Publication
(10) Pub. No.: US 2022/0219537 A1
(43) Pub. Date: Jul. 14, 2022

(54) Method for Operating a Motor Vehicle

(71) Applicant: Volkswagen Aktiengesellschaft, Wolfsburg (DE)

(72) Inventors: Malte Lutz, Mascherode (DE); Felix Pirch, Kiel (DE); Sascha Barton-Zeipert, Braunschweig (DE)

(73) Assignee: Volkswagen Aktiengesellschaft, Wolfsburg (DE)

(21) Appl. No.: 17/609,576

(22) PCT Filed: Mar. 31, 2020
(86) PCT No.: PCT/EP2020/059176

§ 371 Date: Nov. 8, 2021

(30) Foreign Application Priority Data
May 8, 2019 (DE) 10 2019 206 573.2

(51) Int. Cl. B60K 35/00; B60G 17/0165; G06F 3/14; G02B 27/01

(52) U.S. Cl. CPC B60K 35/00; G02B 2027/014; G06F 3/14; G02B 27/0101; B60K 2370/1529; B60K 2370/177; B60K 2370/178; B60K 2370/166; B60K 2370/191; B60K 2370/48; B60K 2370/52; B60G 2500/104; B60G 2400/82; G02B 2027/0141; B60G 17/0165

(57) ABSTRACT

The invention relates to a method for operating a motor vehicle, which has a contactless head-up display, kHUD, which is designed to display virtual contents in superposition with real objects, and furthermore has a semi-active damper system, which is designed to be operated selectively with one of a plurality of damper characteristic curves. In the method according to the invention, a real object located in the direction of travel of the motor vehicle is identified, and virtual content for augmenting the identified real object is determined. In order to prepare for the display of the virtual content, one of the plurality of damper characteristic curves of the semi-active damper system is then selected in order, for example, to optimize both the operation and simulation of the damper system. The virtual content is then displayed, by means of the kHUD, in superposition with the real object, with fewer spatial discrepancies.

### CROSS-REFERENCE TO RELATED APPLICATIONS

This application claims priority to German Patent Application No. DE 10 2019 206 573.2, filed on May 8, 2019 with the German Patent and Trademark Office. The contents of the aforesaid Patent Application are incorporated herein for all purposes.

### TECHNICAL FIELD

The invention relates to a method for operating a motor vehicle, in particular a motor vehicle having a head-up display and an adaptive damper system. The invention also relates to a motor vehicle designed to carry out the method.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

As an extension of classic display systems, what are known as head-up displays, HUDs, are used in motor vehicles. The term head-up display is derived from the fact that these display systems project a display content into the field of vision of a user. Typically, HUDs are based on the projection of display contents onto a transparent screen in front of the user, such as, for example, the windshield of a vehicle. This creates the impression that the display contents are freely floating above the hood in the field of vision of the driver at a distance of approximately two and a half meters.

The driver therefore does not have to adjust, for example, lower (“head-down”) his head position or his viewing direction to perceive the display contents. This is intended to enable the user to direct his field of vision at an area in front of the vehicle without interruption. In conventional display means such as, for example, screens arranged in the armrest of a vehicle, the user may not perceive the events occurring in front of the vehicle for a short time when looking at the display means.

The development of HUD concepts into what are known as contact-analog head-up displays, kHUDs, is also known, which enable the transparent superposition of the distant viewing range of the driver and in particular the display of virtual information in superposition with a relevant object in the street image with the aid of augmented reality, AR, technology. For example, a person warning indicator may be displayed in superposition with the person in the distant viewing range of the driver. With these kHUDs, however, spatial and temporal discrepancies between the superimposed view of the virtual display over the real object have a particularly negative effect on the impression of the superposition and accordingly on the functionality of the system.

Starting from an initially spatially and temporally correct superimposed display of a real object with virtual contents, in particular movements of the vehicle body lead to such spatial and temporal discrepancies. The movements of the vehicle body are typically induced by the roadway being driven or by acceleration and steering processes of the vehicle. Compensating for the body movements through adapted display of the virtual contents is conceivable, but it requires an exact knowledge of the movements of the vehicle body. Known sensors and methods for predicting vehicle body movements are not capable of providing information about these movements with high accuracy and simultaneously low latency.

### SUMMARY

A need exists to reduce or overcome the disadvantages of the prior art and to provide a method for operating a motor vehicle, for example a motor vehicle with a kHUD, which minimizes discrepancies when displaying real objects with superimposed virtual information.

The need is addressed by the subject matter of the independent claims. Embodiments of the invention are described in the dependent claims, the following description, and the drawings.

### BRIEF DESCRIPTION OF THE DRAWINGS

FIGS. 1A-1B show an exemplary augmented display of a roadway located in front of a vehicle with a navigation path and person warning;

FIG. 2 shows an exemplary pitching angle curve of a motor vehicle on a testing route for various chassis settings;

FIG. 3A-3B show an exemplary schematic illustration and calculation of the effect of the pitching angle on an augmented display in a head-up display;

FIG. 4 shows a schematic representation of a motor vehicle according to an embodiment; and

FIG. 5 shows a schematic diagram of the method carried out by the control unit.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

One exemplary aspect relates to a method for operating a motor vehicle, wherein the motor vehicle has at least one contactless head-up display, kHUD, and a semi-active damper system. The kHUD is designed to display at least one virtual content in superposition with at least one real object. The real object is, for example, a person located in front of the vehicle, and the virtual content is, for example, a person warning indicator. Alternatively, the real object is a traffic sign and the virtual content is a traffic sign indicator. Likewise, the real object may be a turn in the road and the virtual content may be a navigation instruction. Additional design possibilities of an augmented display are known to the person skilled in the art.

The semi-active damper system of the vehicle is a damper system that is designed to be operated selectively with one of a plurality of damper characteristic curves. Damper systems may be divided basically into three groups, namely passive, active, and semi-active damper systems. Passive damper systems may only be adapted to an expected road or route profile once by selecting the components of the damper system, in particular springs and dampers. In active damper systems, parts such as springs and dampers are replaced by actuators, which generate the forces otherwise applied by these passive parts. Semi-active damper systems, on the other hand, continue to use springs and dampers, but the damper characteristic curves may be changed over wide ranges by means of suitable actuation. The motor vehicle of the method according to the present aspect has a semi-active damper system.

In some embodiments, the semi-active damper system is designed so that a flow of a fluid used in the damper is adapted. This is done in some embodiments in that the flow resistance experienced by the fluid is adapted by means of (proportional) adjustment valves. Also in some embodiments, the rheological properties of the used fluid itself are adapted. In the case of magneto- or electrorheological fluids, this is in some embodiments done by applying a suitable electromagnetic field. In some embodiments, the semi-active damper system is designed to adapt the experienced flow resistance and to adapt the rheological properties of the fluid (fluid viscosity). The damper characteristic curve of the semi-active damper system defines the response (reaction such as, for example, insertion depth) of the damper to an acting force, for example for a plurality of active forces of different strengths and/or lasting for different amounts of time. The damper characteristic curve may be saved as such and/or describe the real behavior of the damper, which may be continuously adjusted, for example, via a valve value.

In addition, the motor vehicle used in the method according to the present aspect also has additional components, as will be explained in greater detail in the following. In particular, the motor vehicle used in the method has a control unit that is designed to carry out the method according to the teachings herein.

In the method according to another exemplary aspect, a real object located in the direction of travel of the motor vehicle is identified. The identification of the real object is typically preceded by detecting the real object. This detection for example takes place by means of at least one first sensor designed to detect surroundings information. The first sensor in some embodiments is a camera, a detector based on ultrasound, or a detector based on laser light (LIDAR). Typically, automatic identification of the object by signal processing methods, for example by algorithmic image segmentation and image recognition, typically follows the detection of the real object. Such methods are known to the person skilled in the art and may be carried out using artificial intelligence.

As a result of this, information about a real object located in the direction of travel of the motor vehicle is present, wherein this information has a specification of the object (for example, category: traffic sign, type: speed limit; sub-type: max. 130 km/h) and position information of the object. The position information comprises here in particular a distance and a relative orientation to the vehicle. The position information is in some embodiments detected directly by the vehicle (for example, by means of LIDAR) and/or derived computationally from detected image information (for example, based on known extents of objects).

In the method, virtual content for augmenting the identified real object is furthermore determined. As described in the preceding, various indicators for augmenting various classes of real objects are in some embodiments used. These indicators differ, for example, in color, shape, size, and the like. As also described, navigation instructions are used for augmenting the course of a route, wherein the navigation instruction may also depend on a planned route guidance of the motor vehicle. Also in some embodiments, the selection of the virtual content is dependent on user preferences and/or user settings.

In the method, the virtual content is also displayed in superposition with the real object by means of the kHUD. Here, the virtual content is projected onto a projection surface such that the projection is perceived by a driver of the motor vehicle in superposition with the real object. The positioning of the virtual content depends here not only on the relative position of the real object to the motor vehicle, but also on the relative position of the driver, in particular of the driver's eyes, to the projection surface. The relative position of the real object to the motor vehicle is derived from the position information and the relative position of the driver to the motor vehicle is in some embodiments stored in a control unit of the motor vehicle and is in some embodiments based on an initial configuration and/or a user profile of the driver.

The projection surface is in some embodiments the entire surface of a transparent screen or the windshield of the motor vehicle in which the virtual content may in principle be displayed by means of an HUD. In some embodiments, the virtual content is projected into a field of vision of the driver by means of the HUD via the projection surface. The projection surface here serves primarily to reflect the projected virtual content into the field of vision of the driver. Due to the transparency of the screen or the windshield, this reflection takes place as on a semi-permeable mirror. The driver thus perceives the virtual content projected by the HUD as superimposed with the environment (or respectively roadway) located behind the windshield.

In the method, in order to prepare for the display of the virtual content, in particular to prepare for the display of the virtual content in superposition with the real object, one of the plurality of damper characteristic curves of the semi-active damper system is also selected. This enables a clear characterization of the semi-active damper system in preparation for the display, wherein such a characterization may be used in various ways. As described in detail in the following, the clear characterization may be used for targeted actuation of the chassis at the moment of the display of the augmented virtual content and for simulated calculation of the vehicle body movement.

The augmented display of the virtual content typically does not take place continuously but only temporarily, for example for situational augmentation of real objects located temporarily in the direction of travel of the vehicle. In other words, the augmented display of the virtual content only takes place at a specific point in time or only for a specific time period.

Selecting one of the plurality of damper characteristic curves of the semi-active damper system in preparation for the display of the virtual content thus refers to selecting one such damper characteristic curve in advance and with regard to the display. In other words, the selection takes place not only in advance but also temporally correlated with, meaning in preparation for, the display. In particular, the selection takes place within a predetermined time period before the display and/or within a predetermined time period after determining a virtual content for augmentation of the identified real object. Thus, in the method, the method step of determining a virtual content for augmenting the identified real object triggers the method step of selecting one of the plurality of damper characteristic curves of the semi-active damper system in preparation for the display of the virtual content.

In some embodiments, the damper characteristic curve is selected such that an expected vehicle body movement is minimized. It is known from the prior art that various settings of the semi-active damper system lead to different vehicle body movements with the same forces acting on the vehicle (for example, by a road profile or acceleration or steering processes). Thus, a specific setting or respectively a specific damper characteristic curve of a semi-active damper system may be assigned to a specific average vehicle response to a defined active force. This also allows at least one damper characteristic curve to be identified which minimizes a resulting movement of the vehicle body when the effect on the motor vehicle remains the same. In some embodiments, such a damper characteristic curve is selected in the method to prepare for the augmented display of the virtual content.

In some embodiments, the method also has the method step of operating the semi-active damper system with the one selected damper characteristic curve in the moment of the display of the virtual content. At the moment of the display of the virtual content, the movement of the vehicle body is actually minimized in that the selected damper characteristic curve for example is selected so that an expected vehicle body movement is minimized. Thus, in the method, reducing the probability and/or amplitude of vehicle body movements counteracts the occurrence of discrepancies between the position of the displayed virtual content and the real object. The display is typically only augmented for a short time so that the semi-active damper system may in some embodiments be only operated with the one selected damper characteristic curve for a short time, for example within a predetermined interval around the augmented display. This keeps the driving behavior and comfort of the vehicle largely stable.

In some embodiments, the semi-active damper system is designed to operate with continuously changeable damper properties. As already described in the preceding, it is known from the prior art that different operating modes of a semi-active damper system, i.e., different damper characteristic curves, have an enormous influence on vehicle body movements. A plurality of known semi-active damper systems, however, works not with such predefined operating modes, but is designed to operate with continuously changeable damper properties. For example, any flow for continuously opening or closing a valve installed in the damper strut may be applied to set the damper behavior. The degree of openness of the valve and thus the damper characteristic curve therefore change continuously, or respectively in any number of stages.

In such a damper system, however, one of the plurality of damper characteristic curves is selected to prepare for the augmented display. In this case, the one selected damper characteristic curve is in some embodiments a predefined damper characteristic curve of the semi-active damper system and in some embodiments corresponds to a defined operating mode. The selection of a specific damper characteristic curve enables a clear characterization of the semi-active damper system even in a continuously adjustable damper system. This is beneficial both for the operation of the damper system and for the simulation of the motor vehicle during the augmentation. It is thus ensured during operation that movement of the vehicle body is minimized. The simulation of the motor vehicle with a clearly characterized damper characteristic curve enables precise display corrections to be determined for the augmented display.

In some embodiments, an expected vehicle body movement of the motor vehicle is also determined based on the selected one damper characteristic curve. Irrespective of the original cause of the vehicle body movement, the damper characteristics are always included in the mathematical or respectively computational determination of the vehicle response. By using the selected, exactly characterized damper characteristic curve, the determination of the vehicle response is also made more specific and improved. According to this embodiment, the display of the virtual content in superposition with the real object is also adapted to compensate for the expected vehicle body movement of the motor vehicle.

In some embodiments, the display of the virtual content is adapted by shifting a projection position of the virtual content in a direction opposite to the expected vehicle body movement. If it is determined, for example, that an upward pitching movement of the front of the vehicle body is expected, the projection position is shifted downwards. Likewise, in response to an expected clockwise rolling movement, a counterclockwise rolling movement of the projection position takes place. In response to any yawing of the vehicle body to the left, it may possibly be responded to by displacing the projection position to the right. All shifts of the projection position relate here to the projection surface (windshield) from the perspective of the driver. Adapting the display ensures that the virtual content overlaps with the real object despite vehicle body movements and/or a degree of overlap remains high.

In some embodiments, the method also comprises the following method steps for realizing the determination of the expected vehicle body movement. First, a steering and/or acceleration instruction of a driver is detected. In other words, an actuation of a gas or brake pedal and a pressing depth of the pedal are detected.

Alternatively, a direction and an amplitude of a steering movement are detected. Based on these inputs, a vehicle body movement expected in response to the steering and/or acceleration instructions of the driver is determined using a driving dynamics model. The driving dynamics model here forms a mathematical frame for modeling a movement of the driving body in response to an acceleration of the vehicle and taking into account the inertia of the vehicle. Such driving dynamics models are known to the person skilled in the art, such as, for example, the model of the double-mass oscillator. Such driving dynamics models are dependent in particular on implemented characteristic curves/parameters for describing the respective vehicle, in addition to the steering and/or acceleration instructions of the driver (accelerating, braking, steering) and in addition to environmental conditions, such as, for example, a road profile.

The damper characteristic curve of a damper system of the vehicle plays a key role for the driving dynamics model. According to this embodiment, the one determined damper characteristic curve is used in the driving dynamics model. Thus, the requirement of a successful modeling is met by selecting the damper characteristic curve in the method. In combination with the operation of the damper system with the selected damper characteristic curve, the prediction accuracy of the driving dynamics model for the vehicle body movement is also increased.

Alternatively or additionally, the following method steps for determining an expected vehicle body movement also take place in the method. First, a road height profile located in front of the vehicle is detected. Here, a road height profile is understood to mean information about a vertical course of a roadway, in particular via a height section of a roadway. In the context of the present application, the road profile relates to the entire width or only a part of the width of the roadway. In some embodiments, the road profile relates to a vehicle lane, in particular a vehicle lane of the motor vehicle carrying out the method.

In some embodiments, the road height profile located in front of the motor vehicle is detected by means of at least one first sensor of the motor vehicle. The first sensors are designed to detect at least one surroundings signal of the motor vehicle and comprise, for example, a camera and/or distance sensors. Further and in some embodiments, a road height profile driven over by the motor vehicle is detected by means of at least one second sensor of the motor vehicle. The second sensors are designed to detect at least one status signal of the motor vehicle and comprise, for example, sensors for measuring the insertion depth of the dampers or the like. The data detected by the second sensors is in some embodiments used to improve the data acquisition by means of the first sensors.

Based on the detected data, according to this embodiment, a vehicle body movement expected in response to a road height profile located in front of the vehicle is also for example determined by means of a vehicle model. The vehicle model forms a mathematical frame for modeling a movement of the driving body in response to a road height profile. Such driving dynamics models are known to the person skilled in the art, such as, for example, the model of the double-mass oscillator. The vehicle model may exist separately or integrated with the driving dynamics model. In the method, the one selected damper characteristic curve is used in the vehicle model. Thus, the requirement for a successful modeling is also met in this embodiment. In combination with the operation of the damper system with the selected damper characteristic curve, the prediction accuracy of the vehicle model for the vehicle body movement is also increased.

In some embodiments, the semi-active damper system is also precontrolled using the one damper characteristic curve selected in the method according to the present aspect and using the detected road height profile located in front of the vehicle. In particular, a point in time is first determined at which the motor vehicle drives over a specific section of the road height profile. Furthermore, the damper system is controlled such that it has a setting at this point in time that corresponds to the selected damper characteristic curve. The setting for example relates to the degree of openness of an adjustment valve and/or the viscosity of a damping fluid. In other words, the damper system is set in advance and thus with increased reliability. Also, the precontrolled damper system is in some embodiments a damper system of a chassis component.

The method of the present exemplary aspect may be implemented by electrical or electronic parts or components (hardware), by firmware (ASIC), or achieved when executing a suitable program (software). In some embodiments, the method according to the present exemplary aspect is achieved or respectively implemented by a combination of hardware, firmware, and/or software. For example, individual components for carrying out individual method steps are designed as a separately integrated circuit or arranged on a joint integrated circuit. Individual components configured to perform individual method steps are furthermore in some embodiments arranged on a (flexible) printed circuit board (FPCB/PCB), a tape carrier package (TCP), or another substrate.

The individual method steps of the present exemplary aspect are further and in some embodiments designed as one or more processes that run on one or more processors in one or more electronic computing devices and are created when executing one or more computer programs. In this case, the computing devices are for example designed to work together with other components, for example a communication module as well as one or more sensors, or respectively cameras, to achieve the functionalities described here. The instructions of the computer programs are for example stored in a memory such as for example a RAM element. The computer programs may however also be stored on a non-volatile storage medium such as for example a CD ROM, a flash memory, or the like.

A person skilled in the art will see that the functionalities of multiple computers (data processing devices) may be combined or may be combined in a single device or that the functionality of a specific data processing device may be distributed on a plurality of devices to execute the steps of the method without deviating from the teachings herein.

Another exemplary aspect relates to a motor vehicle, in particular a passenger car with an internal combustion engine, electric motor or hybrid motor, which has at least one first sensor designed to detect surroundings data, at least one second sensor designed to detect vehicle data, a contact-analog head-up display, a semi-active damper system, and a control unit designed to carry out the method as described herein.

The at least one first sensor is designed to detect sensor signals relating to the surroundings of the vehicle. The at least one second sensor is designed to detect sensor signals relating to the vehicle itself. In this case, an surroundings signal received by means of the at least one first sensor in some embodiments enables the motor vehicle to inform itself about its environment and for example models a plurality of environment information. A status signal received by means of the at least one second sensor in some embodiments enables the motor vehicle to inform itself about its own state and depicts a plurality of status information for this purpose.

Other embodiments result from the remaining features specified in the dependent claims. The various embodiments mentioned herein may be combined with one another, unless specified otherwise in individual cases.

The invention will be discussed in the following using further embodiments based on the associated drawings.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

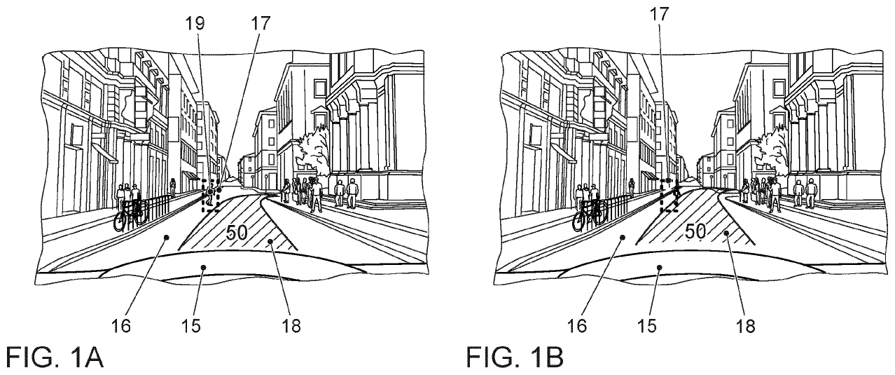

FIG. 1 schematically illustrates an augmented display of a roadway located in front of a vehicle with a navigation path and person warning.

In an ideal case, a contact-analog display of a navigation notice and a person warning indicator takes place in a head-up display of a motor vehicle so that the navigation notice with the course of the road to be driven and the person warning indicator with a person located in front of the vehicle is augmented. In other words, the respective notices or respectively indicators are superimposed as projected virtual contents so that they coincide with the corresponding real objects.

In FIG. 1(A), such an ideal case of an augmented display of virtual contents in superposition with real objects is shown. In FIG. 1(B), on the other hand, virtual content, namely the person warning indicator, is not augmented so that it coincides with the corresponding real object, namely the person located in front of the vehicle. Instead, the virtual content is displayed offset to the side from the real object. This discrepancy between the virtual content and the real object may be attributed to a movement of the vehicle body. Such spatial and temporal discrepancies between virtual contents and real objects negatively affect the impression of the superposition and accordingly the functionality of the head-up display system. The method according to the teachings herein therefore provides a solution for preventing such discrepancies.

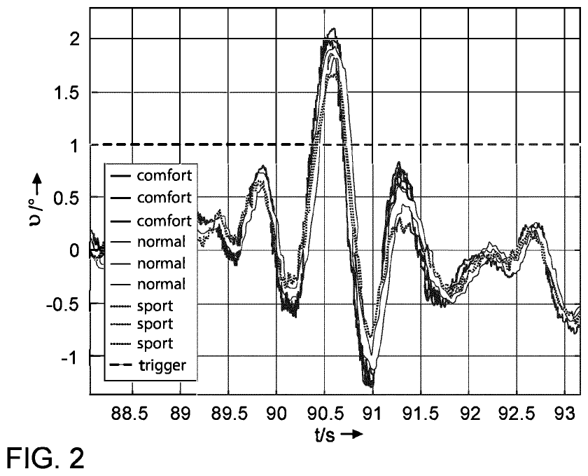

FIG. 2 shows a pitching angle curve of a motor vehicle on a testing route for various chassis settings. Test drives with various motor vehicles have shown that an occurring vehicle response depends on corresponding chassis settings. In particular, an influence of a regulatable semi-active damper on the vehicle body movement becomes apparent. As may be seen clearly in FIG. 2, considerable differences in a pitching angle determined by measurement technology result when driving over a representative testing route, in particular a predetermined trigger, for various damper settings, in particular for settings “comfort,” “normal,” and “sport.” The differences in the pitching angle response to the same trigger may be up to 0.5° here.

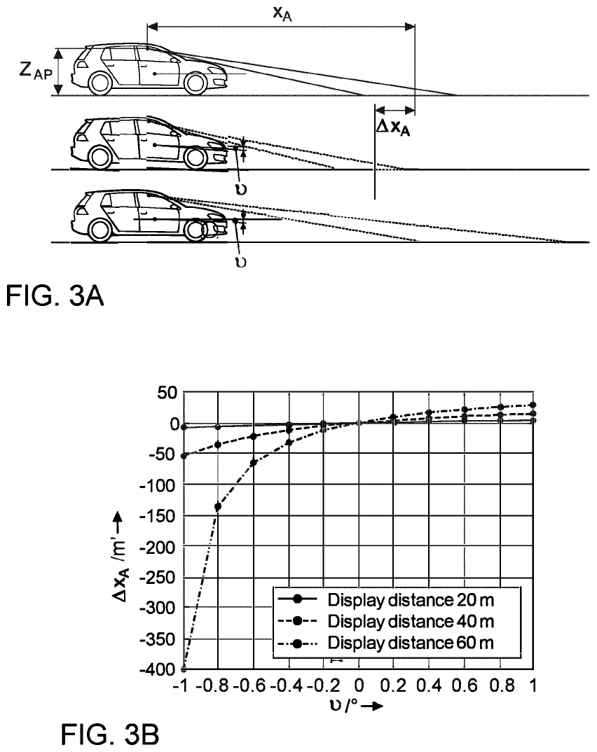

FIG. 3(A) shows schematic illustrations of the effect of the pitching angle on an augmented display in a head-up display. In this case, the uppermost motor vehicle is in a normal position with a neutral pitching angle equal to 0°. The vehicle shown in the middle below has a negative pitching angle ν due to a road height profile, for example a pothole, or a negative acceleration. This leads to an apparent shift of virtual content displayed in the head-up display by Δx_{A} nearer to the vehicle. The lowermost vehicle has a positive pitching angle ν due to a road height profile, for example a bump, or a positive acceleration. This leads to an apparent shift of virtual content displayed in the head-up display away from the vehicle. Assuming that the virtual content and the real object in the case of the uppermost vehicle were still augmented to coincide, spatial discrepancies are thus present in the case of the middle and lower vehicles.

FIG. 3(A) shows numbers calculated by means of a vehicle model for the spatial discrepancy Δx_{A} in meters depending on a pitching angle ν. As may be seen in FIG. 3(B), the magnitude of the spatial discrepancy depends on the distance of the real object from the motor vehicle, due to the intercept theorem. The farther a real object is from the vehicle, the greater the spatial discrepancy created by a pitching angle variation. As also shown in FIG. 3(B), in the case of a typical display distance of an augmentation of approx. 60 m between the real object and the motor vehicle, a pitching angle difference of 0.5° may already lead to a discrepancy Δx_{A} of 50 m. It must be noted that larger display distances and as a result larger discrepancies in kHUDs are certainly possible, since in principle there is no limitation to the distance.

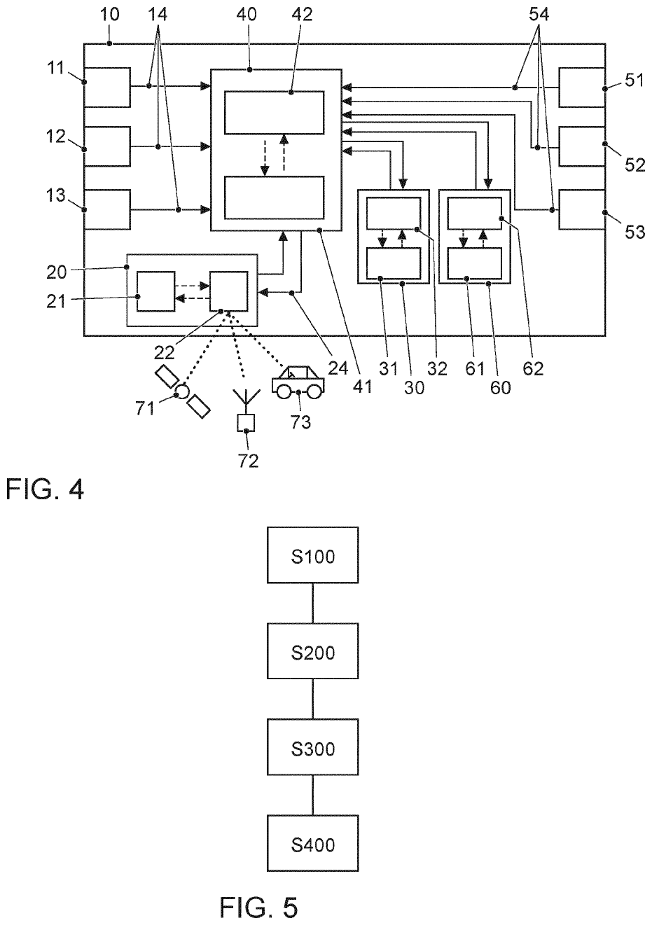

FIG. 4 shows a schematic representation, in particular a block diagram, of a motor vehicle 10, in particular a motor vehicle with an electric or hybrid motor.

The motor vehicle 10 comprises a plurality of first sensors, in particular a first sensor 11, a second sensor 12, and a third sensor 13. The first sensors 11, 12, 13 are designed to detect environment information or respectively surroundings data of the motor vehicle 10 and comprise, for example, a LIDAR system or other distance sensors such as, for example, ultrasonic sensors for detecting distances to real objects or persons located in front of the motor vehicle 10. For example, the second sensor 12 is an infrared sensor and the first sensor 11 is a camera 11 for detecting an image of an environment surrounding the vehicle 10 or persons. The first sensors 11, 12, 13 transfer the surroundings signals detected by them to a control unit 40 of the motor vehicle 10.

The motor vehicle 10 also has a plurality of second sensors, in particular a fourth sensor 51, a fifth sensor 52, and a sixth sensor 53. The second sensors 51, 52, 53 are sensors for determining status data relating to the motor vehicle 10 itself such as, for example, current position and movement information of the motor vehicle. The second sensors are consequently, for example, speed sensors, acceleration sensors, inclination sensors, interior motion detectors, pressure sensors in the vehicle seats, or the like. The second sensors 51, 52, 53 transfer the status signals detected by them to the control unit 40 of the motor vehicle 10.

The motor vehicle 10 also has a communication module 20 with an internal memory 21 and one or more transponders or respectively transceivers 22. The transponders 22 are radio, WLAN, GPS or Bluetooth transceivers or the like. The transponder 22 communicates with the internal memory 21 of the communication module 20, for example, via a suitable data bus. By means of the transponder 22, the current position of the motor vehicle 10, for example, may be determined through communication with a GPS satellite 71 and stored in the internal memory 21. The communication module 20 communicates with the control unit 40. The communication module 20 is also designed to communicate with an external server 72 of a service provider and with another vehicle 73. For example, the communication module 20 is designed to communicate via a UMTS (universal mobile telecommunication service) or LTE (long-term evolution) mobile communication network.

At least some of the second sensors 51, 52, 53 of the motor vehicle 10 transmit their measurement results directly to the driving system 30. These data that are transmitted directly to the driving system are in particular current position and movement information of the motor vehicle. These are for example detected by speed sensors, acceleration sensors, inclination sensors, etc.

The motor vehicle 10 also has a head-up display 30 for projecting virtual contents onto a projection surface, in particular a windshield, of the motor vehicle 10. The head-up display 30 is designed as a contact-analog head-up display and thus designed for augmented display of virtual contents in superposition with real objects. For this purpose, the head-up display has in particular a projector 31 and a lens system 32, which together are designed to project virtual contents into the field of vision of a driver at changing positions on the windshield.

The vehicle 10 also has a damper system 60, in particular a semi-active damper system 60. The damper system 60 has in particular the dampers 61 of the front axle and the dampers 62 of the rear axle. Each of the dampers 61, 62 of the damper system 60 is for example equipped with an electrically regulatable and/or controllable adjustment valve. The flow resistance experienced by the damping fluid may thereby be set accordingly by control signals received by the control unit 40 and thus the characteristic curves of the dampers 61, 62 may be adapted over wide ranges. Thus, the damper system may be operated with a plurality of damper characteristic curves. Furthermore, the damper system 60 transmits information to the control unit 40, for example about the insertion depth of the dampers 61, 62.

The motor vehicle 10 also has a control unit 40, which is designed to carry out the method according to the teachings herein, as explained in detail in the following. For this purpose, the control unit 40 has an internal memory 41 and a CPU 42 which communicate with each other, for example via a suitable data bus. In addition, the control unit is in a communicating connection with at least the first sensors 11, 12, 13, the second sensors 51, 52, 53, the communication module 20, the driving system 30, and the adaptive damper system 60, for example via one or more particular CAN connections, one or more particular SPI connections, or other suitable data connections.

A schematic block diagram of the method carried out by the control unit 40 is shown in FIG. 5. In a first step S100, a real object located in the direction of travel of the motor vehicle 10 is identified. This step for example comprises detecting the real object by means of at least one first sensor 11, 12, 13 and identifying the real object in a signal detected by means of the at least one first sensor 11, 12, 13 by the control unit 40.

In a second step S200, the control unit 40 determines virtual content for augmenting the identified real object. For example, for an identified person in the direction of travel of the vehicle, a person warning indicator is determined as virtual content. In contrast, a navigation notice is determined as virtual notices for a road turn identified, for example, using the GPS satellite 71 and a camera 11.

In another step S300, to prepare for the display of the virtual content by means of the HUD 30 in superposition with the identified real object, one of the plurality of damper characteristic curves of the semi-active damper system 60 is selected. The damper characteristic curve is selected here such that an expected vehicle body movement is minimized. Furthermore, the selected damper characteristic curve is used at the point in time of the augmentation (see step S400) for the operation of the damper system 60. Finally, the selected damper characteristic curve is used to determine an expected vehicle body movement, for example in response to the steering and/or acceleration instructions of the driver and/or in response to a road height profile located in front of the vehicle.

In a step S400, the virtual content is finally displayed in superposition with the real object by means of the kHUD 30. In this case, spatial discrepancies between the virtual content and the real object are reduced, both by the operation of the dampers 60 with suitable damper settings and by adapting the display of the virtual content to compensate for the expected vehicle body movements of the motor vehicle, which have been determined using the selected damper characteristic curve.

### LIST OF REFERENCE NUMERALS

10 Motor vehicle
11 First sensor (camera)
12 Second sensor (infrared sensor)
13 Third sensor
14 Surroundings signal
15 Hood
16 Roadway
17 Augmented person warning
18 Navigation notice
19 Augmented person
20 Communication module
21 Memory
22 Transponder
24 Communication signal
30 Head-up display
31 Projector
32 Lens system
40 Control unit
41 Memory
42 CPU
51 Fourth sensor
52 Fifth sensor
53 Sixth sensor
54 Vehicle signal
60 Adaptive damper system
61 Front axle damper
62 Rear axle damper
71 Satellite
71 Server
73 Other vehicle

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” used throughout the specification means “serving as an example, instance, or exemplification”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for operating a motor vehicle having a contactless head-up display, kHUD, which is configured to display virtual contents in superposition with real objects, and a semi-active damper system, which is configured to be operated selectively with one of a plurality of damper characteristic curves, comprising:
identifying a real object located in the direction of travel of the motor vehicle;
determining virtual content for augmenting the identified real object; and
displaying the virtual content in superposition with the real object using the kHUD, wherein
to prepare for the display of the virtual content, one of the plurality of damper characteristic curves of the semi-active damper system is selected.

2. The method of claim 1, wherein the one damper characteristic curve is selected such that an expected vehicle body movement is minimized.

3. The method of claim 1, comprising: operating the semi-active damper system with the one selected damper characteristic curve at the moment of displaying the virtual content.

4. The method of claim 1, wherein the semi-active damper system is configured for operation with continuously changeable damper properties, and wherein the one selected damper characteristic curve is a predefined damper characteristic curve of the semi-active damper system.

5. The method of claim 1, comprising:
determining the expected vehicle body movement of the motor vehicle based on the selected one damper characteristic curve; and
adapting the display of the virtual content in superposition with the real object to compensate for the expected vehicle body movement of the motor vehicle.

6. The method of claim 5, wherein adapting the display of the virtual content comprises a shifting of a projection position of the virtual content in a direction opposite to the expected vehicle body movement.

7. The method of claim 5, comprising:
detecting one or more of a steering instruction and an acceleration instruction of a driver; and
determining a vehicle body movement expected in response to one or more of the steering instruction, and the acceleration instruction of the driver using a driving dynamics model, wherein the one determined damper characteristic curve is used in the driving dynamics model.

8. The method of claim 5, comprising:
detecting a road height profile located in front of the vehicle; and
determining a vehicle body movement expected in response to the road height profile located in front of the vehicle using a vehicle model,
wherein the one selected damper characteristic curve is used in the vehicle model.

9. The method of claim 8, comprising:
precontrolling the semi-active damper system using the one selected damper characteristic curve and using the detected road height profile.

10. A motor vehicle, having at least one first sensor configured to detect surroundings data, at least one second sensor configured to detect vehicle data, a contact-analog head-up display, kHUD, a semi active damper system, and a control unit configured for:
identifying a real object located in the direction of travel of the motor vehicle;
determining virtual content for augmenting the identified real object; and
displaying the virtual content in superposition with the real object using the kHUD, wherein
to prepare for the display of the virtual content, one of the plurality of damper characteristic curves of the semi-active damper system is selected.

11. The method of claim 2, comprising: operating the semi-active damper system with the one selected damper characteristic curve at the moment of displaying the virtual content.

12. The method of claim 2, wherein the semi-active damper system is configured for operation with continuously changeable damper properties, and wherein the one selected damper characteristic curve is a predefined damper characteristic curve of the semi-active damper system.

13. The method of claim 3, wherein the semi-active damper system is configured for operation with continuously changeable damper properties, and wherein the one selected damper characteristic curve is a predefined damper characteristic curve of the semi-active damper system.

14. The method of claim 2, comprising:
determining the expected vehicle body movement of the motor vehicle based on the selected one damper characteristic curve; and
adapting the display of the virtual content in superposition with the real object to compensate for the expected vehicle body movement of the motor vehicle.

15. The method of claim 3, comprising:
determining the expected vehicle body movement of the motor vehicle based on the selected one damper characteristic curve; and
adapting the display of the virtual content in superposition with the real object to compensate for the expected vehicle body movement of the motor vehicle.

16. The method of claim 4, comprising:
determining the expected vehicle body movement of the motor vehicle based on the selected one damper characteristic curve; and
adapting the display of the virtual content in superposition with the real object to compensate for the expected vehicle body movement of the motor vehicle.

17. The method of claim 6, comprising:
detecting one or more of a steering instruction and an acceleration instruction of a driver; and
determining a vehicle body movement expected in response to one or more of the steering instruction and the acceleration instruction of the driver using a driving dynamics model, wherein the one determined damper characteristic curve is used in the driving dynamics model.

18. The method of claim 6, comprising:
detecting a road height profile located in front of the vehicle; and
determining a vehicle body movement expected in response to the road height profile located in front of the vehicle using a vehicle model,
wherein the one selected damper characteristic curve is used in the vehicle model.

19. The method of claim 7, comprising:
detecting a road height profile located in front of the vehicle; and
determining a vehicle body movement expected in response to the road height profile located in front of the vehicle using a vehicle model,
wherein the one selected damper characteristic curve is used in the vehicle model.

20. The method of claim 18, comprising:
precontrolling the semi-active damper system using the one selected damper characteristic curve and using the detected road height profile.
